(19) United States
(12) Patent Application Publication
(10) Pub. No.: US 2013/0025688 A1
(43) Pub. Date: Jan. 31, 2013

(54) No-Contact Wet Processing Tool with Fluid Barrier

(71) Applicants: Glen Egami, San Jose, CA (US); Aaron Francis, San Jose, CA (US)

(72) Inventors: Glen Egami, San Jose, CA (US); Aaron Francis, San Jose, CA (US)

(73) Assignee: INTERMOLECULAR, INC., San Jose, CA (US)

(21) Appl. No.: 13/192,677

(22) Filed: Jul. 28, 2011

(51) Int. Cl. B01D 47/00

(52) U.S. Cl. 137/1; 137/565.17

(57) ABSTRACT

Embodiments of the present invention describe substrate processing tools and methods. The substrate processing tool includes a housing defining a chamber and a substrate support coupled to the housing and configured to support a substrate within the chamber. The substrate has an upper surface with a first portion and a second portion surrounding the first portion. An isolation unit including a body is coupled to the housing and positioned within the chamber above and spaced apart from the first portion of the upper surface of the substrate. The body includes at least one outlet on a lower surface thereof, which is in fluid communication with at least one fluid pump. The at least one fluid pump is configured to drive fluid through the at least one of outlet to form a barrier around the first portion of the upper surface of the substrate.

### FIELD OF THE INVENTION

The present invention relates to apparatus and method for performing wet processing on a substrate. More particularly, this invention relates to a wet processing tool having site isolation, which does not contact the surface of the substrate to be processed.

### BACKGROUND OF THE INVENTION

Combinatorial processing enables rapid evaluation of semiconductor, solar, or energy processing operations. The systems supporting the combinatorial processing are flexible to accommodate the demands for running the different processes either in parallel, serial or some combination of the two.

Some exemplary processing operations include operations for adding (depositions) and removing layers (etch), defining features, preparing layers (e.g., cleans), doping, etc. Similar processing techniques apply to the manufacture of integrated circuit (IC) semiconductor devices, flat panel displays, optoelectronics devices, data storage devices, magneto electronic devices, magneto optic devices, packaged devices, and the like. As feature sizes continue to shrink, improvements, whether in materials, unit processes, or process sequences, are continually being sought for the deposition processes. However, semiconductor and solar companies conduct research and development (R&D) on full wafer processing through the use of split lots, as the conventional deposition systems are designed to support this processing scheme. This approach has resulted in ever escalating R&D costs and the inability to conduct extensive experimentation in a timely and cost effective manner. Combinatorial processing as applied to semiconductor, solar, or energy manufacturing operations enables multiple experiments to be performed at one time in a high throughput manner. Equipment for performing the combinatorial processing and characterization must support the efficiency offered through the combinatorial processing operations.

### BRIEF DESCRIPTION OF THE DRAWINGS

Various embodiments of the invention are disclosed in the following detailed description and the accompanying drawings:

FIG. 1 is a simplified cross-sectional schematic view of a substrate processing tool, according to one embodiment of the present invention;

FIG. 2 is a perspective view of a processing chamber within the substrate processing tool in FIG. 1;

FIG. 3 is a cross-sectional side view of an isolation unit body and a portion of a substrate within the substrate processing tool in FIG. 1;

FIG. 4 is a plan view of the isolation unit body along line 4-4 in FIG. 3;

FIG. 5 is a cross-sectional side view of an isolation unit body and a portion of the substrate within the substrate processing tool in FIG. 1, according to another embodiment of the present invention;

FIG. 6 is a plan view of the isolation unit body along line 6-6 in FIG. 5;

FIG. 7 is a simplified cross-sectional schematic view of a substrate processing tool, according to another embodiment of the present invention

FIG. 8 is a cross-sectional side view of an isolation unit body and a portion of a substrate within the substrate processing tool in FIG. 7;

FIG. 9 is a plan view of the isolation unit body along line 9-9 in FIG. 8;

FIG. 10 is a cross-sectional side view of an isolation unit body and a portion of the substrate within the substrate processing tool in FIG. 7, according to a another embodiment of the present invention; and

FIG. 11 is a plan view of the isolation unit body along line 11-11 in FIG. 10.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Generally, the present invention provides a substrate processing tool that allows portions of the upper surface of the substrate to be isolated from liquids on the other portions of the upper surface of the substrate, without contacting the upper surface of the substrate. The isolation is accomplished using, for example, a combination of fluid barriers as seals and vacuum removal.

At each location to be isolated, an isolation unit (or reactor) is placed in close proximity with the upper surface of the substrate. The reactor has an outlet (or array of outlets) that is sized and shaped similar to a periphery of the location on the substrate to be isolated. Barrier fluid (e.g., a gas or liquid) is driven through (either out of or in to) the outlet, which causes a fluid barrier to be formed around the respective location. The gas barrier prevents processing fluid (e.g., a gas or liquid) on the substrate from flowing between the respective location and the remainder of the substrate. The barrier may be used to contain processing fluid within the particular location or prevent processing fluid on the remainder of the substrate from flowing onto the particular location.

The outlet may be an annular trench that surrounds a central receptacle of the reactor. A second, annular trench/outlet may also be provided, which surrounds the first trench/outlet. The second trench may be provided with a gas flow opposite the first trench. For example, if gas is driven out of the first trench, a vacuum may be applied to the second trench, and vice versa. Positive pressure may also be applied to the central receptacle of the reactor when the reactor is being used to prevent liquid from flowing onto the respective location of the substrate. Additionally, the flow of gas may generate Bernoulli forces (suction) that may be used to lift the substrate, without contacting the substrate.

According to one aspect of the present invention, a substrate processing tool is provided. The substrate processing tool includes a housing defining a chamber. A substrate support is coupled to the housing and configured to support a substrate within the chamber. The substrate has an upper surface with a first portion and a second portion surrounding the first portion. An isolation unit including a body (or reactor) is coupled to the housing and positioned within the chamber above and spaced apart from the first portion of the upper surface of the substrate. The body includes at least one outlet on a lower surface thereof. At least one fluid pump is in fluid communication with the at least one outlet and is configured to drive fluid through the at least one outlet to form a barrier around the first portion of the upper surface of the substrate.

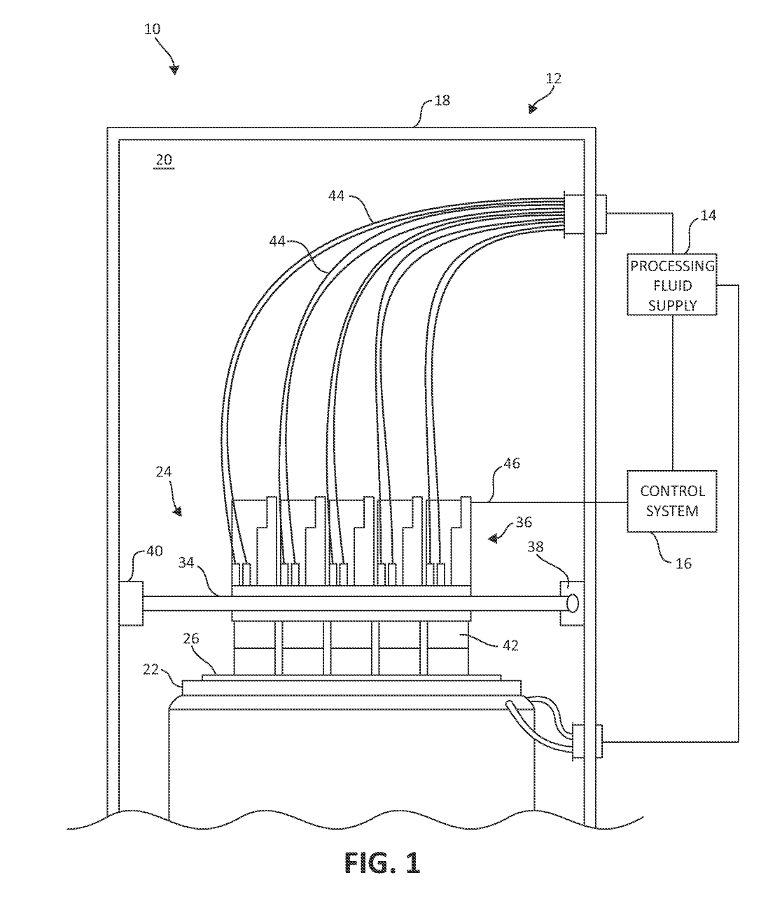

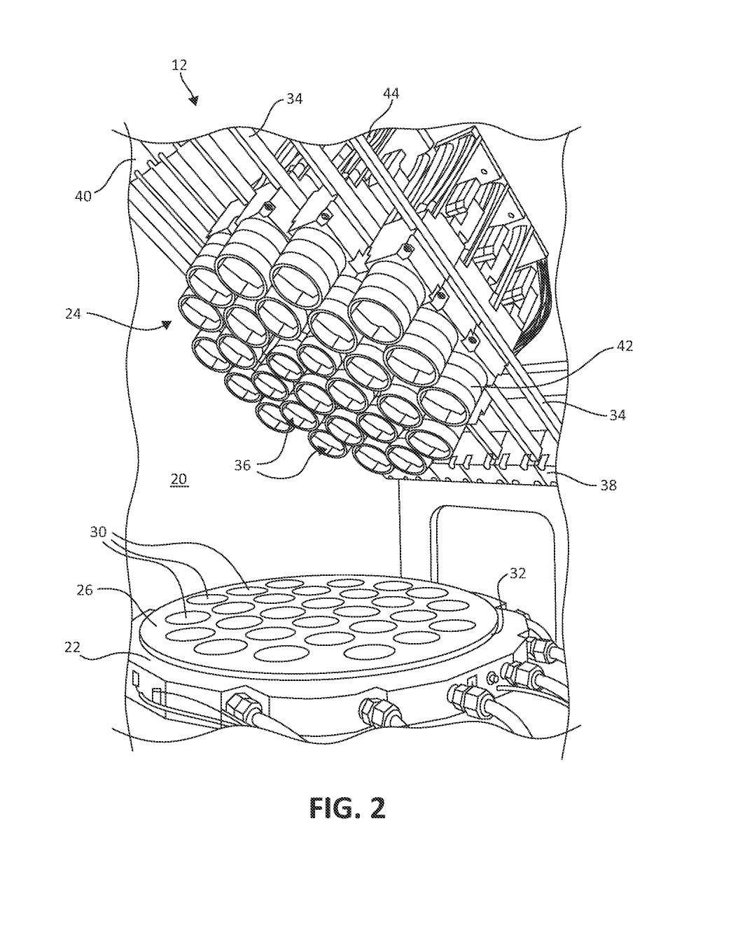

FIGS. 1 and 2 illustrate a substrate processing tool (or system) 10, according to one embodiment of the present invention. The substrate processing tool 10 is a “wet” processing tool, as is commonly understood, and includes a wet processing apparatus 12, a processing fluid supply (or supply system) 14, and a control system 16. As will be described in greater detail below, the substrate processing tool 10 shown in FIGS. 1 and 2 may be used to perform processing steps on distinct, isolated regions of a substrate, as opposed to the “interstitial” regions between the isolated regions.

The wet processing tool 12 includes a housing 18 enclosing (or defining) a processing chamber 20, a substrate support 22, and a wet processing assembly 24. The substrate support 22 is positioned within the processing chamber 20 and is configured to hold a substrate 26.

Although not shown in detail, the substrate support 22 may be configured to secure the substrate using, for example, a vacuum chuck, electrostatic chuck, or other known mechanism. Further, although not shown, the substrate support 22 may be coupled to the housing 18 via an actuator (e.g., a pneumatic cylinder) configured to vertically move the substrate support 22, such as for positioning the substrate 26.

Referring specifically to FIG. 2, the substrate 26 includes a series of isolation (or first) regions 30 on the upper surface thereof and an outer edge 32. As is evident in FIG. 2, the regions 30 have widths (or diameters) that are considerably smaller than a width (or diameter) of the substrate 26. As described below, each of the regions 30 may be processed by a corresponding one of multiple isolation units within the wet processing assembly 24. The portion(s) of the substrate 26 outside of the regions 30 may be referred to as an “interstitial” (or second) region (or portion).

The substrate 26 may be a conventional, round substrate (or wafer) having a diameter of, for example, 200 millimeter (mm) or 300 mm. In other embodiments, the substrate 26 may have other shapes, such as a square or rectangular. It should be understood that the substrate 26 may be a blanket substrate (i.e., having a substantial uniform surface), a coupon (e.g., partial wafer), or even a patterned substrate having predefined regions (e.g., regions 30). The regions 30 may have any convenient shape, e.g., circular, rectangular, elliptical, wedge-shaped, etc. In the semiconductor field a region may be, for example, a test structure, single die, multiple die, portion of a die, other defined portion of substrate, or a undefined area of a, e.g., blanket substrate which is defined through the processing.

Referring again to both FIGS. 1 and 2, the wet processing assembly 24 includes a scaffolding 34 and an array of isolation (or wet processing) units 36 attached to the scaffolding 34. The isolation units may be used for wet processing, as described below. The scaffolding 34 extends between end pieces 38 and 40. As shown in FIG. 2, end piece 38 is pivotably (or rotatably) coupled to the housing 18.

As shown in FIG. 2, the isolation units 36 are arranged in a series of rows, with each of the isolation units 36 corresponding to one of the regions 30 on the substrate 26. However, it should be understood that the number and arrangement of the isolation units 36 may differ, as is appropriate given the size and shape of the substrate 26 and the arrangement of the regions 30. Each of the isolation units 36 includes a body (or container or reactor) 42. In some embodiments, the isolation units 36 may also include a transducer actuator housed above the body 42, and a transducer (i.e., megasonic transducer) positioned within the body 42 and coupled to the transducer actuator.

Further, the isolation units 36 may be configured in a variety of ways to provide common mechanisms used in wet processing, such as stiffing and/or mechanical agitation, brush cleans, polishing, and electroplating.

Referring again to FIG. 1, each of the isolation units 36 (and/or the body 42 thereof) is in fluid communication with the processing fluid supply system 14 via a series of fluid lines 44. Further, each of the isolation units 36 is in operable communication with the control system 16 via wiring 46.

The processing fluid supply system 14 includes one or more supplies of various processing fluids, both liquids and gases, as well as temperature control units to regulate the temperatures of the various fluids. Additionally, the processing supply system 14 includes one or more fluid pumps for delivering the fluids to the isolation units 36 and/or providing vacuum supplies to the isolation units 36, as well as a series of valves interconnecting the various supplies and the isolation units 36. The control system 16 includes, for example, a processor and memory (i.e., a computing system) in operable communication with the processing fluid supply system 14 and the isolation units 36 and is configured to control the operation thereof as described below.

Referring now to FIGS. 1 and 2, the substrate 26 is positioned on the substrate support 22 (e.g., by a robot which is not shown) when the substrate support 22 is in a lowered position. The substrate support 22 is then raised such that the bodies 42 of the isolation units 36 are horizontally aligned above the substrate 26 (or a surface thereof). More specifically, each of the isolation units 36 is positioned over, and spaced apart from (i.e., the bodies 42 do not contact the substrate 26), a respective one of the regions 30 on the substrate 26.

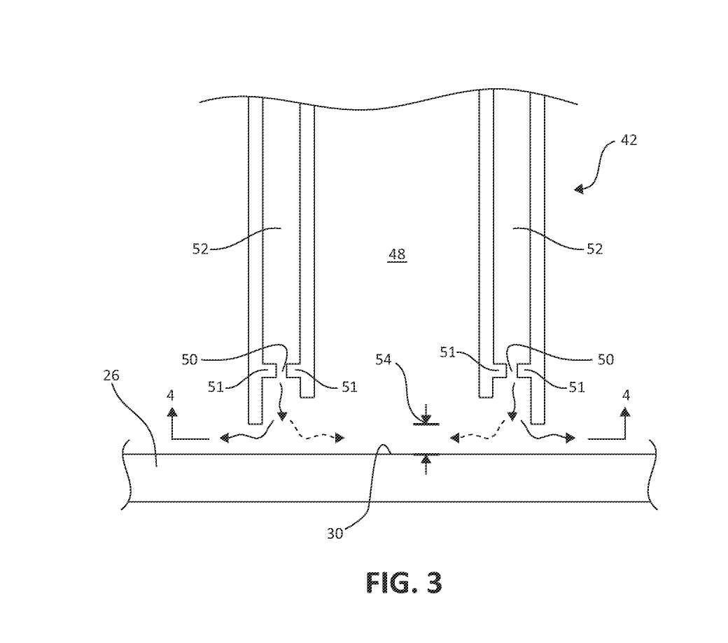

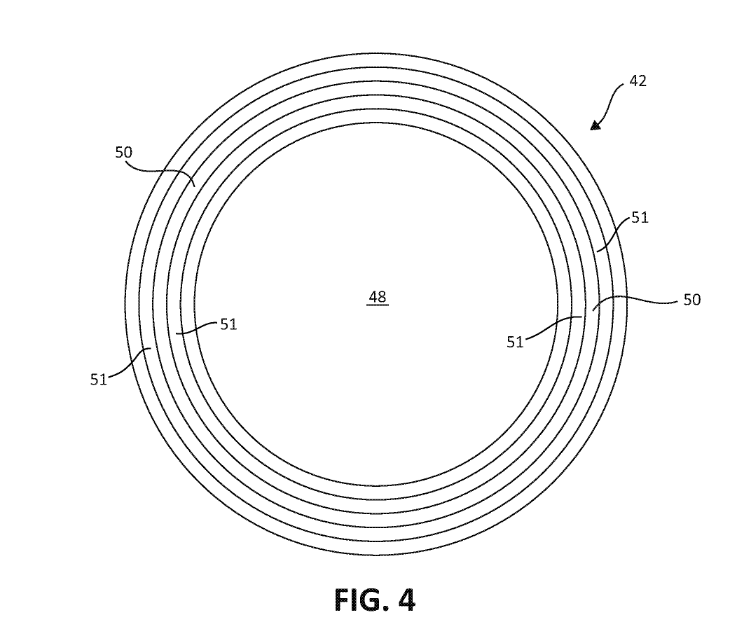

FIGS. 3 and 4 illustrate the body 42 of one of the isolation units 36, as positioned above a respective region 30 on the substrate 26, in greater detail. As shown, the body 42 is substantially cylindrical in shape and includes a central receptacle 48 and an annular trench outlet 50 extending into a lower surface of the body 42. In the embodiment shown, the central receptacle 48, like the body 42 itself, is substantially cylindrical in shape and positioned at a central portion of the body 42.

Although not specifically illustrated, the central receptacle 48 is in fluid communication with the processing fluid supply 14 (e.g., via fluid lines 44 shown in FIG. 1). The trench outlet 50 is formed between annular protrusions 51 within the body 42 and symmetrically surrounds the central receptacle and is in fluid communication with an annular plenum 52 that is in fluid communication with the processing fluid supply 14. Of particular interest is that the body 42 of the isolation unit 36 does not contact the upper surface of the substrate 26. In one embodiment, a distance 54 between the lowest portion of the body 42 and the substrate 26 is, for example, between 0.02 and 0.12 mm (but may be as small as a few micrometers). The body 42 may be made of a chemically inert material, such as polytetrafluoroethylene (PTFE).

In operation, after the wet processing assembly 24 (FIG. 1) is lowered, a wet process, as is commonly understood, is performed on the region(s) 30 on the substrate 26. Examples of wet processes that may be performed on the substrate 26 include wet cleanings, wet etches and/or strips, and electroless depositions.

Referring again to FIG. 3, the operation of the wet processing apparatus 12, illustrated in FIG. 1, will now be described with respect to one of the isolation units 36. However, it should be understood that all of the isolation units 36 may be similarly operated at the same time.

In order to create a barrier around the region 30, a fluid (hereinafter referred to as a “barrier fluid”), such as argon or nitrogen gas, is delivered to the annular plenum 52 in the body 42 of each of the isolation units 36 by the processing fluid supply 14. The barrier fluid flows from the annular plenum 52 through the annular trench outlet 50 and onto the substrate 26, where it flows both inwards towards the center of the respective region 30 on the upper surface of the substrate 26 and outwards, away from the region 30. This gas flow creates an annular fluid barrier around the respective region 30 on the substrate that prevents processing fluid (e.g., a liquid) on the substrate 26 from passing between the region 30 and the interstitial portion of the substrate 26.

Still referring to FIG. 3, a processing fluid (e.g., a liquid), such as a cleaning solution, is then delivered to the central receptacle 48 of the body 42 from the processing fluid supply 14 (FIG. 1). The liquid flows onto the respective region 30 on the substrate 26, where it is restricted from flowing onto the interstitial portion of the substrate 26 by the fluid barrier. As such, as the processing liquid continues to flow into the central receptacle 48, a column of liquid is formed within the isolation unit 36 over the respective region 30 of the substrate 26.

It should be understood that although the barrier fluid may cover the region 30 on the substrate 26 before the processing fluid is delivered into the central receptacle 48, this portion of the barrier may have a relatively low pressure such that the processing fluid “pushes” it back, substantially off the region 30. In contrast, the portion(s) of the barrier directly under the annular trench outlet 50 may have a relatively high pressure, preventing the processing fluid from passing between the region 30 and the interstitial portion of the substrate 26. It should also be understood that in other embodiments, as described below, the flow of the barrier fluid may be reversed, such as for processing the interstitial portion of the substrate 26.

After a predetermined amount of time (i.e., depending on the particular wet process being performed), the liquid may be removed from the central receptacle 48 by the processing fluid supply 14 (i.e., a vacuum supply). As such, the present invention allows for wet processes to be performed on only particular portions of the substrate 26, without any of the components of the tool 10 contacting the upper surface of the substrate 26. Thus, the likelihood that any contaminates will be left on the substrate 26 are reduced.

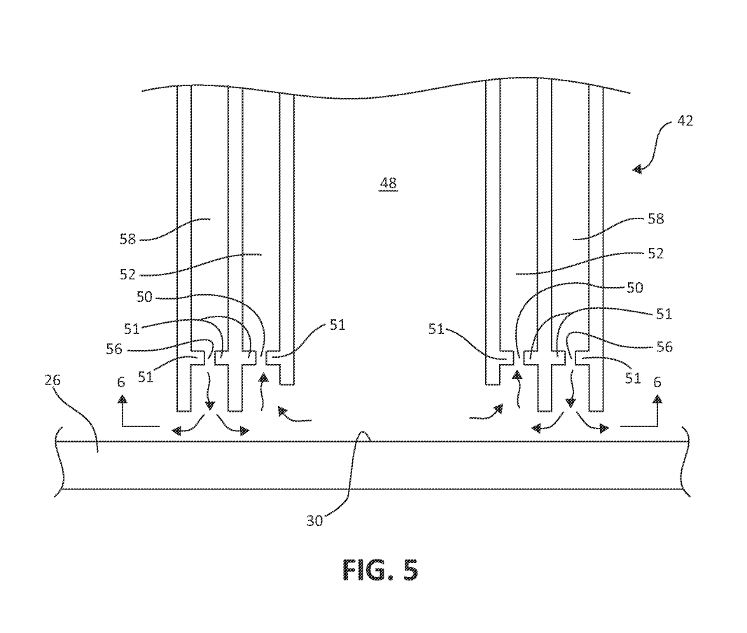

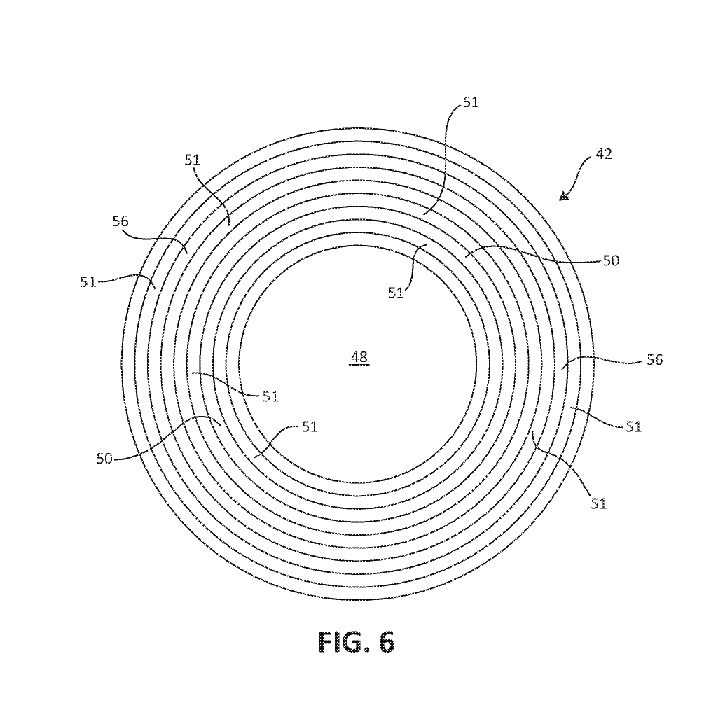

FIGS. 5 and 6 illustrate the body 42 of one of the isolation units 36, as positioned above a respective region 30 on the substrate 26, according to another embodiment of the present invention. As with the embodiment shown in FIGS. 3 and 4, the body 42 includes a central receptacle 48, an (first) annular trench outlet 50, annular protrusions 51, and an (first) annular plenum 52. However, as shown, the body 42 shown in FIGS. 5 and 6 includes a second annular trench outlet 56 and an associated second annular plenum 58, both of which symmetrically surround the central receptacle 48, the first annular trench outlet 50, and the first annular plenum 52.

In operation, according to one embodiment, gas (i.e., barrier fluid) is driven from the second annular trench outlet 56 by the processing fluid supply 14 (FIG. 1). However, simultaneously, a vacuum is applied (e.g., by the processing fluid supply 14) to the first annular plenum 52 such that gas (e.g., a portion of the gas driven from the first annular trench outlet 50), is pulled upwards through the first annular trench outlet 50 and into the first annular plenum 52.

Processing fluid, such a processing liquid, is then delivered into the central receptacle 48, as described above, to perform a wet process on the respective region 30 of the substrate 26. The gas driven from the second annular trench outlet 56 combined with the gas pulled through the first annular trench outlet 50 forms a gas or fluid barrier similar to that described above.

However, the embodiment shown in FIGS. 5 and 6 provides an additional advantage in that if any of the processing liquid is able to flow across the substrate 26 through the fluid barrier, it will be removed from the surface of the substrate 26 along with the gas that is pulled into the first annular trench outlet 50. As a result, the likelihood that any of the processing liquid contacts the interstitial portion of the substrate 26 is even further reduced. Such an embodiment may be particularly useful with low surface tension processing liquids.

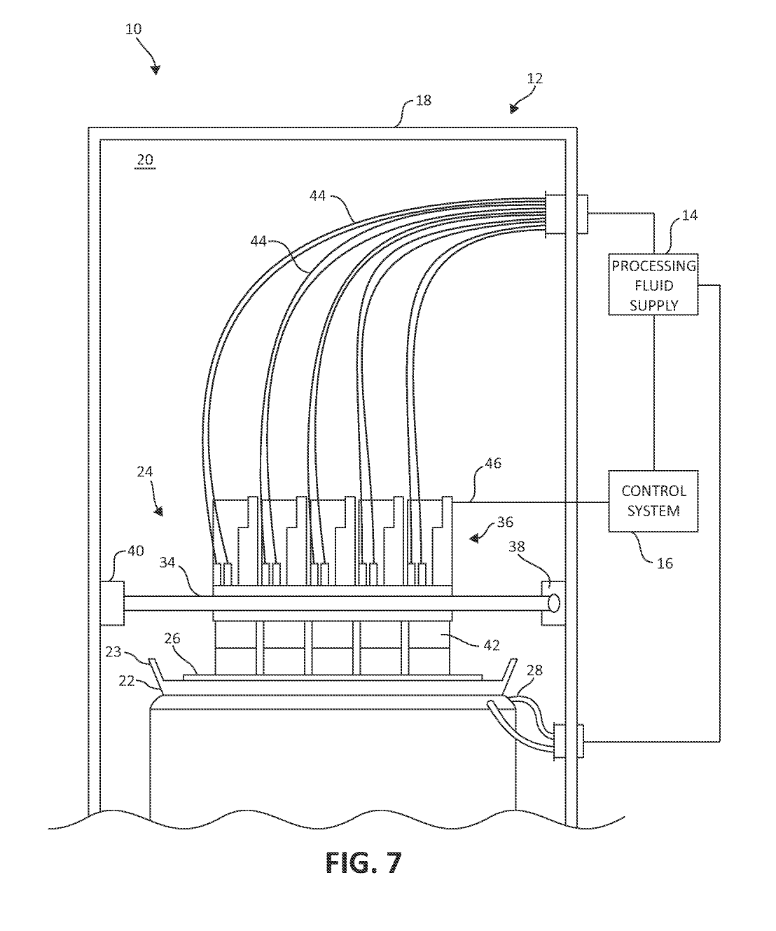

FIG. 7 illustrates a substrate processing tool (or system) 10, according to another embodiment of the present invention. The embodiment shown in FIG. 7 may be used to process the “interstitial” portion of the substrate 26 (FIG. 2). As with the embodiment described above, the tool 10 includes a wet processing apparatus 12, a processing fluid supply (or supply system) 14, and a control system 16. Of particular interest in FIG. 7 is that the substrate support 22 includes a lip 23 extending upwards (i.e., to a height greater than a thickness of the substrate 26) around a periphery thereof. The lip 23 extends around the entire substrate support such that a interstitial container or tub is formed, the use of which is described in greater detail below. Additionally, the substrate support 22 may have a series of fluid passageways extending therethrough (and connected to the interstitial container) which are in fluid communication with the processing fluid supply system 14 via support fluid lines 28.

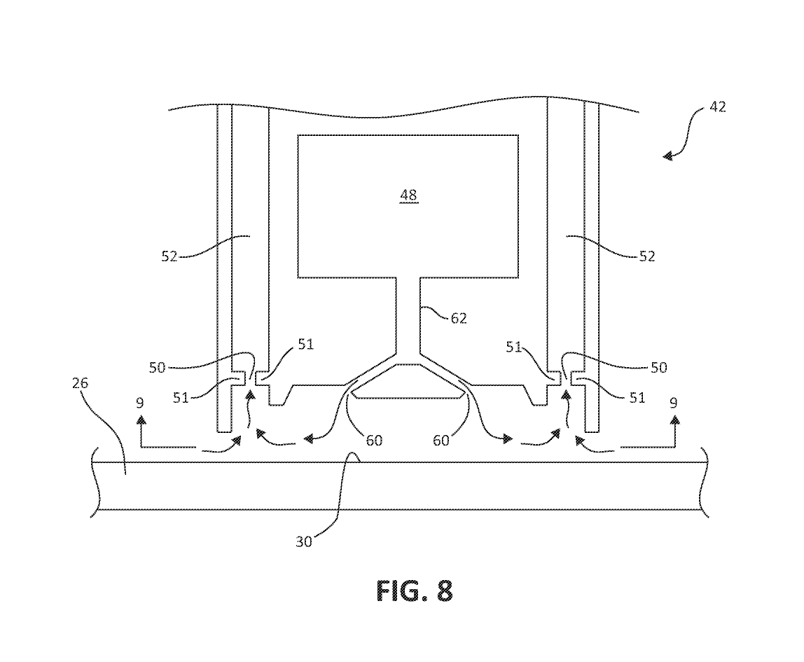

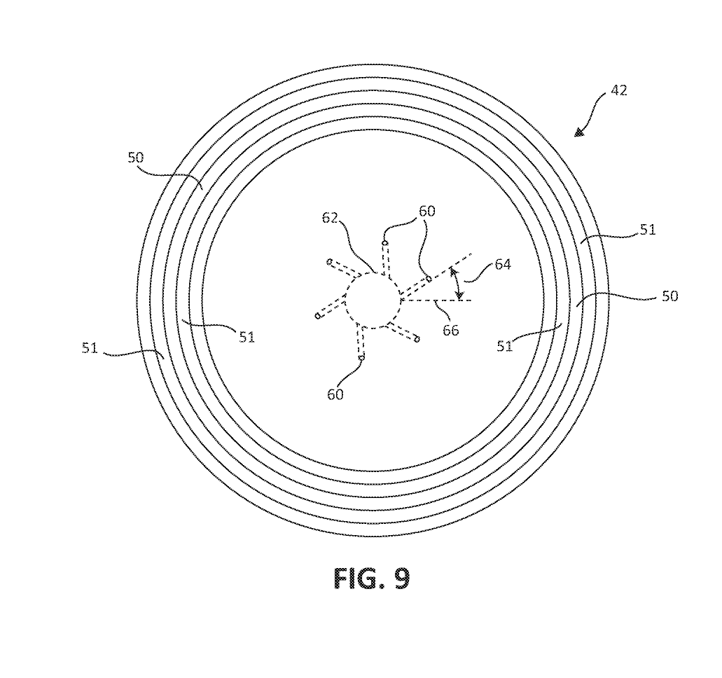

FIGS. 8 and 9 illustrate the body 42 of one of the isolation units 36 in the tool shown in FIG. 7, according to one embodiment of the present invention. Similar to the embodiment shown in FIGS. 3 and 4, the body 42 shown in FIGS. 8 and 9 includes a single annular trench outlet 50 and the associated annular plenum 52, along with the central receptacle 48. However, the size of the central receptacle 48, which is in fluid communication with the processing fluid supply 14, has been reduced to form a central plenum. A series of outlets 60 extend into the lower surface of the body 42 and are in fluid communication with the central receptacle 48 through a central channel 62.

As shown in FIG. 9, the outlets 60 extend from the central channel 62 at an angle 64 from a radial line 66 (i.e., a line that intersects a central axis of the body 42). In the example shown, six outlets 60 are included (although this number may vary in other embodiments) and are symmetrically arranged around the central channel 62 in a substantially annular or circular manner.

During operation, in one embodiment, positive pressure is applied to the central receptacle 48 (e.g., barrier gas is delivered to the central receptacle 48) while the annular plenum 52 is “vented” (i.e., connected to a vent at atmospheric pressure). As a result, barrier fluid (e.g., a gas) is driven from the central outlet 60 towards the substrate 26. Because of the angle 64 at which the outlets 60 are arranged, the gas extends outwards towards the annular trench outlet 50 in a “swirling” motion and is directed upwards into the annular trench outlet 50, as is a small portion of gas and/or air from outside of the isolation unit 36. Thus, a fluid barrier is formed around the respective isolation region 30 (FIGS. 2 and 8).

Referring again to FIG. 7, processing liquid is then delivered into the interstitial container formed by the lip 23 on the substrate support 22 by the processing fluid supply 14 such that the substrate 26 is submerged in the processing liquid. However, because of the fluid barrier form by each isolation unit 36, the processing liquid is restricted from flowing onto the isolation regions 30, and only covers the interstitial portion of the substrate 26. As a result, only the interstitial portion of the substrate 26 is processed. Additionally, if any of the processing liquid begins to flow near the periphery of the isolation regions 30, the liquid is pulled upwards into the annular trench outlet 50, along with the barrier gas.

Further, the embodiment shown in FIGS. 8 and 9 may be used to transport the substrate 26. That is, because of the flow of gas (i.e., from the central outlet 60 and into the annular trench outlet 50) a Bernoulli force is generated, which causes the substrate 26 to be pulled towards the body 42, and/or vice versa, as the atmospheric pressure within the processing chamber 20 is greater than the pressure over the isolation region 30. The flow of gas may be calibrated such that the force is sufficient to lift the substrate 26 from the substrate support while not allowing the body 42 to contact the substrate 26.

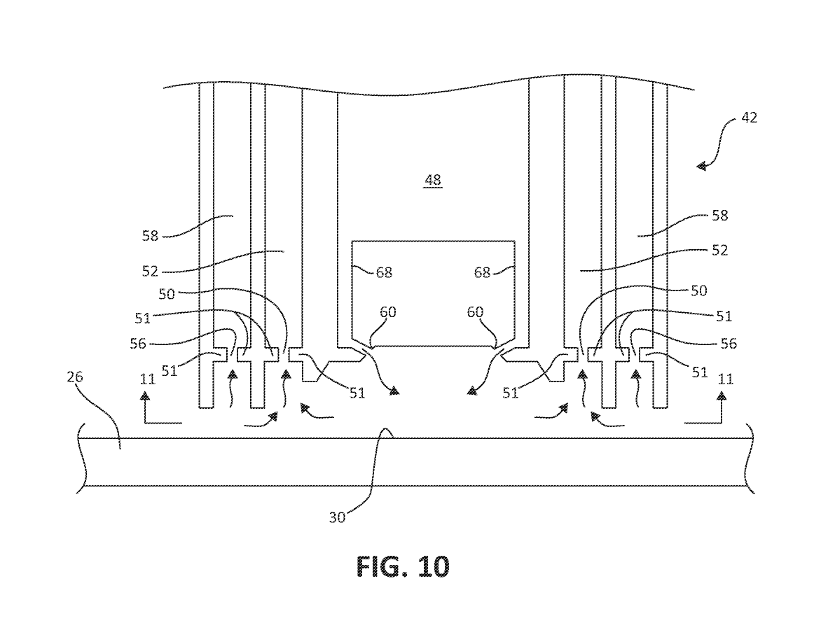

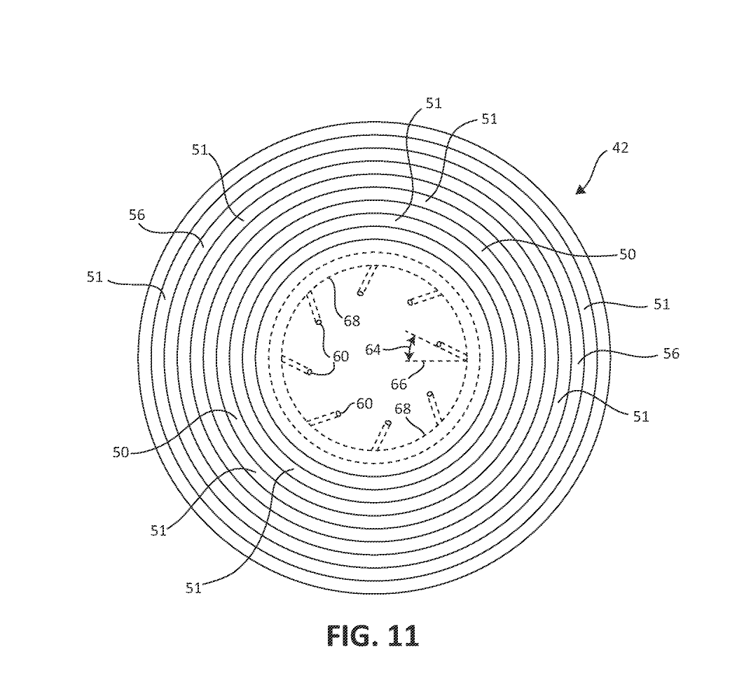

FIGS. 10 and 11 illustrate the body 42 of one of the isolation units 36, as positioned above a respective region 30 on the substrate 26, according to a further embodiment of the present invention. As with the embodiment shown in FIGS. 5 and 6, along with the (first) annular trench outlet 50 and annular plenum 52, the body 42 includes a second annular trench outlet 56 and second annular plenum 58.

Additionally, similar to the embodiment shown in FIGS. 8 and 9, the central receptacle 48 has been reduced in size and is connected to a series of outlets 60. However, in the embodiment shown in FIGS. 10 and 11, the outlets 60 are connected to the central receptacle 48 through an annular channel 68 and extend therefrom towards the center of the body 42. Additionally, similar to the embodiment shown in FIGS. 10 and 11, the outlets 60 extend from the annular channel 68 at an angle 64 from a radial line 66 (i.e., a line that intersects a central axis of the body 42) and are arranged in a substantially annular or circular manner.

During operation, barrier fluid is driven from the outlets 60, a vacuum is applied to the second annular plenum 58, and the first annular plenum 52 is vented (as described above). As a result, gas flows down from the outlets 60 onto the isolation region 30 of the substrate in a “swirling” motion and outwards towards the first annular trench outlet 50. A portion of the barrier fluid is directed upwards through the first annular trench outlet 50, while some of the barrier fluid is pulled into the second annular trench outlet 56. This flow of gas forms a gas barrier around the respective isolation region 30 similar to that described above.

Referring again to FIG. 7, processing liquid is then delivered into the interstitial container formed by the lip 23 on the substrate support 22 such that the substrate is submerged. However, the gas barrier formed by each isolation unit 36 prevents the liquid from flowing onto the respective isolation region 30. Moreover, if any of the processing liquid flows past the fluid barrier formed by the gas from outlets 60, the liquid will be pulled into the second annular trench outlet 56 and/or the first annular trench outlet 50. It should also be noted that the embodiment shown in FIGS. 10 and 11 may also be used to transport the substrate 26 in a manner similar to the embodiment shown in FIGS. 8 and 9, as described above.

The embodiments described herein provide details for a multi-region processing system and associated processing heads that enable processing a substrate in a combinatorial fashion. Exemplary details of combinatorial processing techniques are provided in U.S. Pat. No. 7,544,574, filed on Feb. 10, 2006, and claiming priority from Oct. 11, 2005, U.S. Pat. No. 7,824,935, filed on Jul. 2, 2008, U.S. Pat. No. 7,871,928, filed on May 4, 2009, and claiming priority from Oct. 15, 2005, U.S. Pat. No. 7,902,063, filed on Feb. 10, 2006, and claiming priority from Oct. 15, 2005, and U.S. Pat. No. 7,947,531 filed on Aug. 28, 2009, all of which are assigned to Intermolecular, Inc. (San Jose, Calif.) and incorporated by reference herein. Exemplary details of combinatorial processing techniques are further provided in U.S. patent application Ser. No. 11/352,077, filed on Feb. 10, 2006, and claiming priority from Oct. 15, 2005, U.S. patent application Ser. No. 11/419,174, filed on May 18, 2006, and claiming priority from Oct. 15, 2005, U.S. patent application Ser. No. 11/674,132, filed on Feb. 12, 2007, and claiming priority from Oct. 15, 2005, and U.S. patent application Ser. No. 11/674,137, filed on Feb. 12, 2007, and claiming priority from Oct. 15, 2005, all of which are also assigned to Intermolecular, Inc. (San Jose, Calif.) and are incorporated by reference herein.

As such, according to one aspect of the present invention, the substrate processing tool 10 also is provided with a variation generating system (or subsystem) configured to intentionally vary (or create differences between) the wet processes performed on two or more of the regions 30 and/or the interstitial portion of the substrate 26. The variation generating system may include, for example, the processing fluid supply system 14, the transducers (in embodiments having transducers), and/or the control system 16.

It should be understood that the size, shape, and number of the isolation units 36 and/or the corresponding regions 30 on the substrate 26 may be different in other embodiments. For example, the substrate 26 may include four isolation regions, each substantially covering a “quadrant” of the upper surface, and the isolation units 36 (and/or the bodies 42 thereof) may be appropriately sized and shaped to match.

Thus, in one embodiment, a substrate processing tool is provided. The substrate processing tool includes a housing defining a chamber. A substrate support is coupled to the housing and configured to support a substrate within the chamber. The substrate has an upper surface with a first portion and a second portion surrounding the first portion. An isolation unit including a body is coupled to the housing and positioned within the chamber above and spaced apart from the first portion of the upper surface of the substrate. The body includes at least one outlet on a lower surface thereof. At least one fluid pump is in fluid communication with the at least one outlet and is configured to drive fluid through the at least one outlet to form a barrier around the first portion of the upper surface of the substrate.

In another embodiment, a method for processing a substrate is provided. An isolation unit comprising a body is positioned above and spaced apart from an isolation portion of the upper surface of a substrate. The upper surface of the substrate also includes interstitial portion surrounding the isolation portion. The body includes at least one outlet on a lower surface thereof. Fluid is caused to be driven through the at least one outlet such that a fluid barrier is formed around the isolation portion of the upper surface of the substrate.

In a further embodiment, a substrate processing tool is provided. The substrate processing tool includes a housing defining a chamber. A substrate support is coupled to the housing and configured to support a substrate within the chamber. The substrate has an upper surface with a plurality of isolation portions and an interstitial portion surrounding each of the isolation portions. A plurality of isolation units comprising a body coupled to the housing are positioned within the chamber, each being above a respective one of the isolation portions of the upper surface of the substrate. The body of each of the plurality of isolation units includes an annular outlet on a lower surface thereof. At least one gas pump is in fluid communication with the annular outlet of the body of each of the plurality of isolation units and is configured to drive gas through the annular outlet of the body of each of the plurality of isolation units to form a gas barrier around each of the isolation portions of the upper surface of the substrate.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A substrate processing tool comprising:
a housing defining a chamber;
a substrate support coupled to the housing and configured to support a substrate within the chamber, the substrate having an upper surface with a first portion and a second portion surrounding the first portion;
an isolation unit comprising a body coupled to the housing and positioned within the chamber above and spaced apart from the first portion of the upper surface of the substrate, the body comprising at least one outlet on a lower surface thereof; and
at least one fluid pump in fluid communication with the at least one outlet and configured to drive fluid through the at least one outlet to form a barrier around the first portion of the upper surface of the substrate.

2. The substrate processing tool of claim 1, wherein the body of the isolation unit further comprises a central receptacle extending into the lower surface thereof.

3. The substrate processing tool of claim 2, wherein the at least one outlet of the body of the isolation unit is an annular trench surrounding the central receptacle.

4. The substrate processing tool of claim 3, wherein the at least one fluid pump is configured to drive fluid from the annular trench onto the upper surface of the substrate.

5. The substrate processing tool of claim 3, wherein the at least one fluid pump is configured to apply a vacuum to the annular trench.

6. The substrate processing tool of claim 3, wherein the body of the isolation unit further comprises a second annular trench surrounding the central receptacle.

7. The substrate processing tool of claim 6, wherein the at least one fluid pump is in fluid communication with the second annular trench, and wherein the at least one fluid pump is configured to drive fluid from one of the annular trench and the second annular trench onto the upper surface of the substrate and apply a vacuum to the other of annular trench and the second annular trench.

8. The substrate processing tool of claim 7, wherein the at least one fluid pump is in fluid communication with the central receptacle of the isolation unit.

9. The substrate processing tool of claim 5, wherein the at least one fluid pump is in fluid communication with the central receptacle of the isolation unit and configured to drive fluid from the central receptacle such that the barrier fluid flows from the central receptacle, across the first portion of the upper surface of the substrate, and into the annular trench causing a force to be applied on the substrate towards the isolation unit.

10. The substrate processing tool of claim 1, further comprising an interstitial container coupled to the housing and configured to hold liquid on the second portion of the upper surface of the substrate.

11. A method for processing a substrate comprising:
positioning an isolation unit comprising a body above and spaced apart from an isolation portion of the upper surface of a substrate, the upper surface of the substrate further comprising an interstitial portion surrounding the isolation portion, the body comprising at least one outlet on a lower surface thereof; and
causing fluid to be driven through the at least one outlet such that a barrier is formed around the isolation portion of the upper surface of the substrate.

12. The method of claim 11, wherein the upper surface of the substrate further comprises a plurality of isolation portions, each of the isolation portions being surrounded by the interstitial portion of the upper surface of the substrate, and further comprising:
positioning an isolation unit comprising a body above and spaced apart from each of the plurality of isolation portions of the upper surface of the substrate, the body of each isolation unit comprising at least one outlet on a lower surface thereof; and
causing fluid to be driven through the at least one outlet of each isolation unit such that a fluid barrier is formed around each isolation portion of the upper surface of the substrate.

13. The method of claim 11, wherein the body of the isolation unit further comprises a central receptacle extending into the lower surface thereof and the at least one outlet of the body of the isolation unit is an annular trench surrounding the central receptacle.

14. The method of claim 13, wherein causing fluid to be driven through the at least one outlet comprises driving fluid from the annular trench onto the upper surface of the substrate.

15. The method of claim 14, wherein the body of the isolation unit further comprises a second annular trench surrounding the central receptacle, and wherein causing fluid to be driven through the at least one outlet comprises applying a vacuum to the second annular trench.

16. A substrate processing tool comprising:
a housing defining a chamber;
a substrate support coupled to the housing and configured to support a substrate within the chamber, the substrate having an upper surface with a plurality of isolation portions and an interstitial portion surrounding each of the isolation portions;
a plurality of isolation units comprising a body coupled to the housing, each being positioned within the chamber above a respective one of the isolation portions of the upper surface of the substrate, the body of each of the plurality of isolation units comprising an annular outlet on a lower surface thereof; and
at least one gas pump in fluid communication with the annular outlet of the body of each of the plurality of isolation units and configured to drive gas through the annular outlet of the body of each of the plurality of isolation units to form a gas barrier around each of the isolation portions of the upper surface of the substrate.

17. The substrate processing tool of claim 16, further comprising an interstitial container coupled to the housing and configured to hold liquid on the interstitial portion of the upper surface of the substrate.

18. The substrate processing tool of claim 16, wherein the body of each of the plurality of the isolation units further comprises a central receptacle extending into the lower surface thereof, and wherein the annular outlet surrounds the central receptacle.

19. The substrate processing tool of claim 18, wherein the body of each of the plurality of isolation units further comprises a second annular outlet on the lower surface thereof surrounding the annular outlet and the central receptacle.

20. The substrate processing tool of claim 19, further comprising a processing liquid supply in fluid communication with the central receptacle of each body of the plurality of isolation units.
